(19) United States
(12) Patent Application Publication
(10) Pub. No.: US 2023/0070583 A1
(43) Pub. Date: Mar. 9, 2023

(54) Kinked Thin Tube for Fluid-Pressurized Deployment

(71) Applicant: Kyle Borden Marquis, Boulder, CO (US)

(72) Inventor: Kyle Borden Marquis, Boulder, CO (US)

(21) Appl. No.: 17/468,491

(22) Filed: Sep. 7, 2021

(51) Int. Cl. F16L 11/12; F28F 5/00; B64G 1/50

(52) U.S. Cl. CPC F16L 11/12; F28F 5/00; B64G 1/503

(57) ABSTRACT

A kinked thin tube that deploys, possibly using pressurized fluid, and can transport heat to other structures. Radiator panels attached to the tubes can deploy into a flat plane from a stowed configuration, allowing for efficient storage and reduced mass. Additionally, hollow brackets can be used to connect to the thin tubes structurally and thermally.

### CROSS-REFERENCE TO RELATED APPLICATIONS

This application claims the benefit of provisional patent application Ser. No. 63/075,572, filed Sep. 8, 2020, by the present inventor.

### BACKGROUND

The following is a tabulation of some prior art that presently appears relevant:

U.S. Patents

| Patent Number | Kind Code | Issue Date | Patentee |
|---|---|---|---|
| 3,733,046 | | May 15, 1973 | Irving D. Press |
| 7,469,874 | B2 | Dec. 30, 2008 | Yutaka Akahori |
| 5,246,254 | A | Sep. 21, 1993 | Francis X. LoJacono |

### NONPATENT LITERATURE DOCUMENTS

Brazier, L. G., “On the Flexure of Thin Cylindrical Shells and Other “Thin” Sections,” Proceedings of the Royal Society of London. Series A, Containing Papers of a Mathematical and Physical Character, vol. 116, (773), pp. 104-114, 1927.
Block, J., Straubel, M., and Wiedemann, M., “Ultralight Deployable Booms for Solar Sails and Other Large Gossamer Structures in Space,” Acta Astronautica, 2010.
Lichodziejewski, D., Veal, G., and Derbes, B., “Spiral Wrapped Aluminum Laminate Rigidization Technology,”AIAA 2002-1701. 43rd AIAA/ASME/ASCE/AHS/ASC Structures, Structural Dynamics, and Materials Conference, 2002.
Penn, J., et al., “GPM Solar Array Gravity Negated Deployment Testing,” 42nd Aerospace Mechanisms Symposium, Baltimore, Md., 2014.
Davis, N. et al “Global Precipitation Measurement Mission Launch and Commissioning,” National Aeronautics and Space Administration, 2015.
Schmidt, P. B., “An Investigation of Space Suit Mobility with Applications,” Doctoral Dissertation, Dept. of Aeronautics and Astronautics, Massachusetts Institute of Technology, Cambridge, Mass., 2014.

This patent pertains to thin impermeable tubes that can fold partway, experiencing a kink in one or more regions along the tube. These tubes may allow flow through them while partially restricted, or fully extended.

The term “kink” is often referred to in this document, hereby defined as a type of sharp bend when used in the context of thin tubes. This bend is often associated with a change in the cross-section of the tube close to or after buckling. This is described as “ovalization” for circular thin tubes by Brazier in 1927. Generally, this phenomenon in academia can be found by searching for post-buckling, kinking, bending, wrinkling of inflated beams, thin tubes, etc. Note that while the term kinked is used to describe the tubes in consideration, a tube with multiple, or continuously, bent or flattened sections can also serve the definition.

In determining the novelty of this design, previous research has been conducted as to the closest relevant material. Hoses have been kinked before by almost anyone who water gardens or lawns, pictures exist on the internet, and this is common knowledge. Patents and technology exist to prevent this from occurring, seen from LoJacono in 1992, U.S. Pat. No. 5,246,254. Other products such as metal tubing for laboratories may also develop kinks, however, these products are not meant to bend in this fashion since it restricts flow. Pressure-filled tubes have been folded and used to deploy booms for spacecraft in the past Block et al, 2010). This has been used for booms, sometimes with the purpose to deploy solar panels Lichodziejewski et al, 2002). Furthermore, other examples of inflated kinked tubes are studied for spacesuit mobility applications, like the dissertation from Schmidt in 2001. In this example, these tubes are not used to enable fluid to flow from one end to the other, but to enable mobility for an astronaut.

Tube constriction has relevant patents for this design; one tube valve patent shows a device that flattens a tube to prevent flow (U.S. Pat. No. 3,733,046), another shows one that does kink the tubes into an “m” shape (U.S. Pat. No. 7,469,874). However, these tubes aren't used for deploying anything and are constricted only to prevent flow.

By incorporating fluid that is used to transport heat, and having tubes used for deployment, this becomes a novel idea. Additionally, the use of kinked tubes to deploy radiators specifically is a novel concept as well. Particularly, the combination of heat transport and triggered deployment present an improved radiator concept that can allow for lighter and less complex systems.

Space structures such as solar panels have a heritage in using unfolding designs (Penn, J., et al., 2014). However, this unique unfolding tube system can use a similar idea to efficiently store radiator panels. Specifically, the prior art uses other means to unfold their panels from an originally zigzagged pattern such as electric actuators (Davis, 2015), and this prior art does not use this technique on radiator panels, or to transport heat using fluid. Here, a radiator panel means any assembly of multiple parts that structurally hold the surfaces used to radiate heat to a colder environment.

### SUMMARY

A new deployment mechanism is formulated which utilizes pressurized fluid or external motion to open a thin tube that can transport heat. The application of this can enable spacecraft radiators to become lightweight and compact as these tubes can collapse and be stored flat. One method of doing this is by taking multiple radiator panels and connecting their fluid sections in a zigzag pattern which linearly unfolds during pressurization. This pressurization can come from a pumped fluid loop thermal control system from a spacecraft, as one example. Another method of unfolding is by using an external means to deploy the radiator panels, which can also unfold the kinked tubes and allow flow of the heated fluid to reject the heat away. To achieve this heat rejection, these tubes can be attached to hollow brackets which transfer heat to radiating surfaces using the fluid that flows within it.

The details of the primary embodiment could include but are not limited to circular or oval-shaped tubes and a thickness of under 1 mm. Here, the design is pictured as a normally circular tube composed of a single piece. The tube can be made of any material that can retain fluid and gases for long periods of time without permeation. Here polyimide is selected for its strength and stability at low temperatures, as well as resistance to cracking at a folded joint. Other choices could include variants of polyethylene with or without metalized coatings, metalized BoPET, variants of PET with or without metalized coatings, metals themselves, or a combination of any of these or other materials.

The advantages of this embodiment will become apparent from a study of the following description and accompanying drawings.

### DRAWINGS—FIGURES

FIG. 1 is a thin tube kinked in half

FIG. 2 is a thin tube in its deployed configuration

FIG. 3 is an assembly of multiple radiator panels connected by thin tubes in a stowed configuration

FIG. 4 shows multiple radiator panels connected by thin tubes in a deployed configuration

FIG. 5 shows multiple radiator panels connected by thin tubes with an elastic means of deploying the panels in a stowed configuration

### DRAWINGS—REFERENCE NUMERALS

1 kinked thin tube
2 deployed thin tube
3 hollow bracket
4 frame bracket
5 radiating surfaces
6 radiator panel assembly
7 heated and pressurized fluid
8 means of unfolding panels and tubes

### DETAILED DESCRIPTION

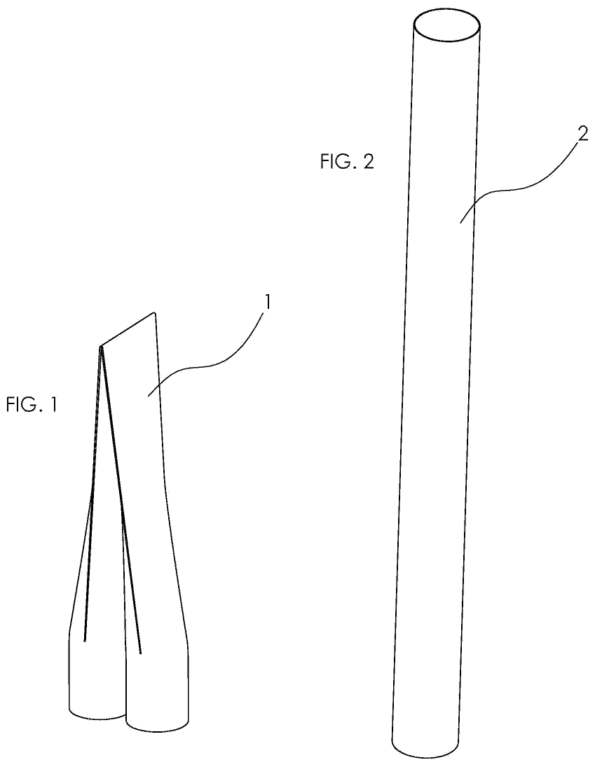

FIG. 1 shows an isometric view of a thin tube, part 1, with a 180-degree kink. This angle is relative to itself when in a neutral, axially aligned state such as in the deployed configuration, 2. This piece is expected to be connected to some sort of hollow attachment on either end to still enable fluid flow while being structurally connected.

FIG. 2 shows a tube in its deployed configuration. The cylindrical shape arises due to either the internal pressure from fluid inside that pushes the inner walls outwards, or the elastic nature returning the deflected geometry to equilibrium. These are also known as the means of unfolding itself using elasticity or pressurized fluid. When initially in the kinked state, 1, this pressure has the effect of opening up the fold by generating a torque on the kinked joint, producing this deployed configuration, 2, and allowing heated fluid to flow through it. Alternatively, external bending at the ends of this tube can also provide the means of opening it up and allow heated fluid to flow. This external means of unfolding the tubes is later shown in FIG. 5.

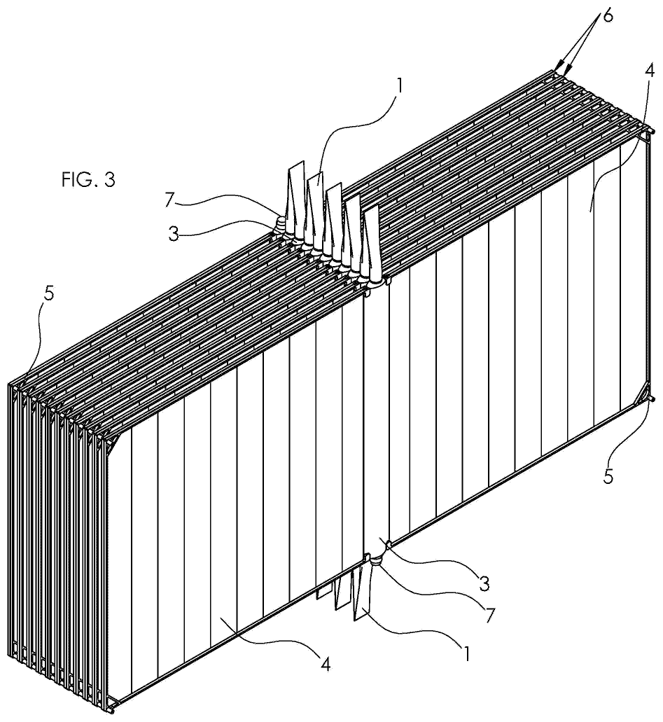

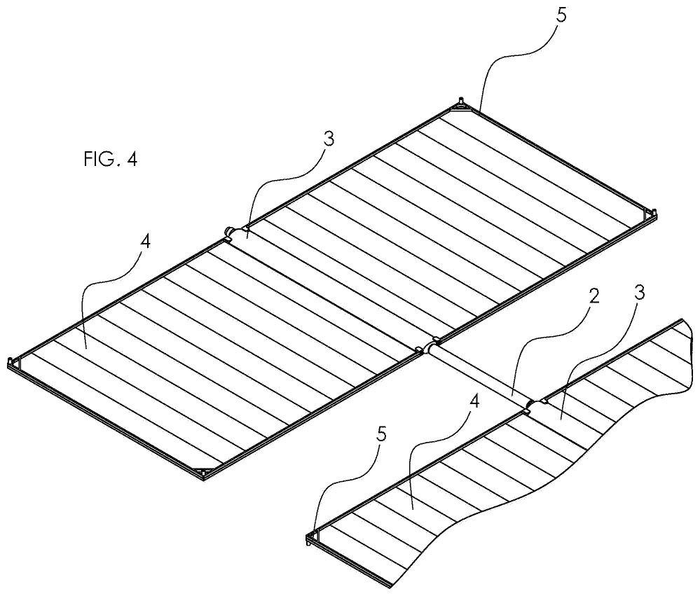

FIG. 3 shows an isometric view of an assembly of multiple radiator panels, 6, connected by kinked tubes, 1, in a zigzag pattern. This assembly is in a stowed configuration where the radiator panels are stacked next to each other to reduce volume. Of most importance in this figure are the kinked tubes since the radiator panels themselves are only examples to show how these tubes can be used to deploy objects. The radiator panels include a hollow bracket, 3, attached to frame brackets on either side, 5, as well as radiating surfaces, 4 which attach to both parts 3 and 5. Note that the hollow brackets, 3, are an example of any structure that may attach to the tubes and are expected to use a means of fastening or adhesion to attach and seal to the tubes. The fluid that could enter and flow through the tubes, 7, is also shown.

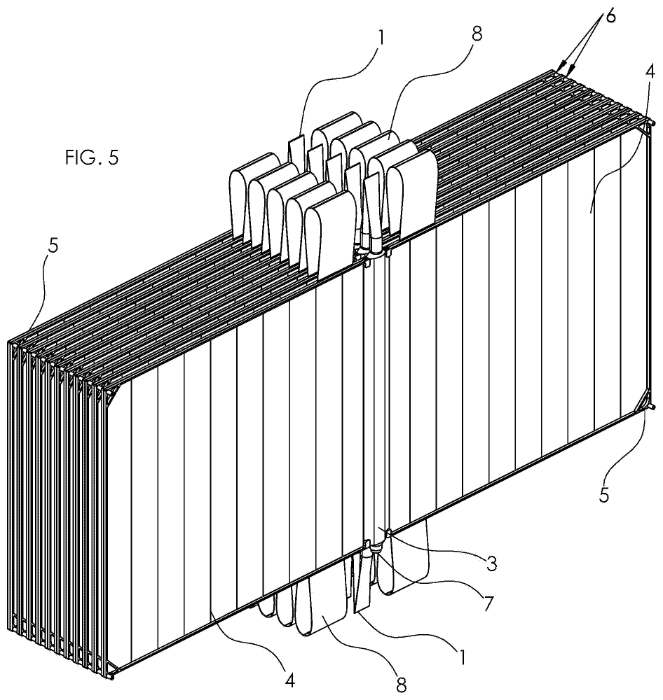

FIG. 4 shows an isometric view of multiple radiator panels, 6, connected by thin tubes in a deployed configuration. Specifically, this is one section of the assembly of panels seen in FIG. 3 where either the tubes have been pressurized with fluid or the panels have been positioned externally, rotating the panels at the kinked joints until this flat, straight, configuration is achieved. This is the desired configuration for radiating heat away from the radiator panels because having a large surface area and open views are required to reject significant heat into a colder environment. The radiator panels again include a hollow bracket, 3, attached to frame brackets on either side, 5, as well as radiating surfaces, 4 which attach to both parts 3 and 5. To show the relevant information in detail, part of the bottommost radiator panel has been cut away to fit the relevant details on the page.

FIG. 5 shows a new isometric view of an assembly of multiple radiator panels, 6, connected by a means of deploying the structure, 8, and kinked tubes, 1, in a zigzag pattern. This means of deploying the structure, 8, also known as a means of unfolding the tubes, here uses the elasticity in its body to open the panels, however, is just an example to perform this function. This assembly is in a stowed configuration wherein the radiator panels are stacked next to each other to reduce volume. The radiator panels include a hollow bracket, 3, attached to frame brackets on either side, 5, as well as radiating surfaces, 4, which attach to both parts 3 and 5. The fluid that could enter and flow through the tubes, 7, is also shown.

### Operation

In operation, one can use this thin tube invention by connecting the ends of each tube to the hollow brackets which can allow fluid to flow within the tube, ideally without leaks. Before deployment, the tube can be either partially filled with fluid or be completely vacated of fluid through pulling a vacuum on the fluid line. To allow deployment, the brackets that connect to the tubes must be allowed to move, such as through unlocking some latching mechanism, or other means of un-rigidizing the brackets that may have been previously rigidized before deployment. The pressurized and possibly heated fluid may be allowed to flow through the tube, possibly opening the tube along with attached structures. This fluid can be hotter than the surrounding environment if the transport of heat is desired. To use with radiator panels, the brackets that attach to the tubes should be used to conduct heat to radiating surfaces. When the tube deploys, it should rotate the radiators with it, positioning them such that they point towards the external environment, such as outer space. If multiple tubes and radiator panels are used, then they can be configured in a stacked zigzag pattern where the fluid flows through one of the tubes, into a bracket at the top, into another tube, into a bracket on the bottom, and repeated as necessary. As a result, the radiator panels lay in a plane spaced apart from each other facing the environment.

### CONCLUSION, RAMIFICATIONS, AND SCOPE

Accordingly, the reader will see that these thin tubes can be used to deploy and transport a significant amount of heat for minimal mass. These tubes can act as hinges to control the deployment of attached structures and ultimately could help reject heat to the surrounding environment through radiator panels. Panels that are stacked in a zigzag configuration can be connected with one or multiple kinks in the thin tubes, allowing the panels to be densely packed. A spacecraft that uses this design could save many kilograms of mass compared to potentially bulky hinges and piping networks.

By using pressurized fluid to open a bent section of a thin tube, it can unfold, acting as hinge as well as an actuation device that can be triggered using fluid flow. This type of actuation system can be combined with a pumped fluid loop thermal control system as used on spacecraft, resulting in the tube performing two tasks simultaneously. Furthermore, a fluid-filled tube can act as a structural member which can, for example, hold radiators out from a spacecraft in the same way that deployable booms are used. Kinked tubes can be used even when deployed through other means, such as externally where the structure attaching to the ends of the tubes moves the tubes. This feature can allow fluid to move through the recently opened tube, carrying heat to a desired location while being simple and lightweight.

Although the description above contains many specificities, these should not be construed as limiting the scope of the embodiments but as merely providing illustrations of some of several embodiments. For example, the tube can come in many shapes or sizes, or connect to other structures than radiators; the mechanism of opening the tubes does not need to be from the fluid pressure itself; the radiator panels can extend into a non-flat configuration using these tubes, etc.

Thus, the scope of the embodiments should be determined by the appended claims and their legal equivalents, rather than by the examples given.

I claim:

1. A thin impermeable tube comprising one or more bent sections totaling at least 45 degrees from horizontal relative to its own undeflected position, a means of unfolding itself using elasticity or pressurized fluid to rotate said bent sections, wherein said tube carries heated fluid for the purpose of transporting heat, whereby said tube can move into its desired position by utilizing said pressurized fluid within and allowing said fluid to transfer heat to another location.

2. The tube according to claim 1 wherein a hollow bracket attaches to said tube through means of fastening or adhesive, heat flows from the fluid to said bracket or vice versa, whereby a structural and thermal connection can be made between said tube and said hollow bracket.

3. The tube according to claim 1 wherein said motion deploys at least one radiator panel for use on spacecraft, whereby said radiator panels can be stowed in a compact manner, deployed using pressurized fluid flowing through the system.

4. The tube according to claim 3 wherein said tube and said radiator panel are connected in series to additional tubes and radiators and together are folded in a zigzag pattern whereby said radiator panels can be compactly stored.

5. A thin impermeable tube comprising a kink that could significantly impede fluid flow, a sealed connection to a structure on at least one side, wherein said tube carries heated fluid after unfolding for the purpose of transporting heat, whereby said kinked tube can be used as a fluid and thermal pathway after unfolding.

6. The tube according to claim 5 wherein said fluid moving through said tube later transfers heat to a radiator panel for heat rejection to the external environment.

7. The tube according to claim 6 wherein said tube is substantially composed of a polymer.

8. The tube according to claim 7 wherein said polymer is substantially composed of polyimide.

9. The tube according to claim 7 wherein said polymer is substantially composed of polyester.

10. The tube according to claim 5 wherein said sealed connection is to a hollow bracket that attaches to said tube through means of fastening or adhesive and heat flows from said fluid to said bracket or vice versa, whereby a structural and thermal connection can be made between said tube and said hollow bracket.

11. A thin impermeable tube comprising a kink that could significantly impede fluid flow, wherein one or both ends of said tube undergo displacement or rotation by means of unfolding said kink, wherein said unfolding motion additionally deploys at least one radiator panel, whereby said tube and radiator panel can move from a folded state into their desired positions while allowing fluid to transfer heat through them for rejection to the environment.

12. The tube according to claim 11 wherein said tube and said radiator are connected in series to additional tubes and radiators and together are folded in a zigzag pattern, whereby said radiator panels can be compactly stored.

13. The tube according to claim 11 wherein said tube is substantially composed of a polymer.

14. The tube according to claim 13 wherein said polymer is substantially composed of polyimide.

15. The tube according to claim 13 wherein said polymer is substantially composed of polyester.
